(19) United States
(12) Patent Application Publication
(10) Pub. No.: US 2015/0022044 A1
(43) Pub. Date: Jan. 22, 2015

(54) SYSTEM AND METHOD FOR REDUCING TORQUE RIPPLE IN AN INTERIOR PERMANENT MAGNET MOTOR

(71) Applicants: Mazharul H. Chowdhury, Midland, MI (US); Mohammad S. Islam, Saginaw, MI (US)

(72) Inventors: Mazharul H. Chowdhury, Midland, MI (US); Mohammad S. Islam, Saginaw, MI (US)

(73) Assignee: STEERING SOLUTIONS IP HOLDING CORPORATION, Saginaw, MI (US)

(21) Appl. No.: 13/947,601

(22) Filed: Jul. 22, 2013

(51) Int. Cl. H02K 1/27

(52) U.S. Cl. CPC H02K 1/274
USPC 310/156.53

(57) ABSTRACT

An interior permanent magnet motor comprises a rotor assembly disposed within a stator assembly. The rotor assembly is configured for rotating about a central axis relatively to the stator assembly. The rotor assembly defines a plurality of magnet pockets within the rotor assembly along a radially outboard surface of the rotor assembly. Each magnet pocket is substantially rectangular in cross-sectional shape, and each magnet pocket is configured to facilitate insertion of a plurality of permanent magnets into and retention of the plurality of permanent magnets within, the magnet pocket. The rotor assembly further comprises a plurality of permanent magnet segments disposed in each magnet pocket.

### BACKGROUND OF THE INVENTION

The subject invention relates to system and method for reducing torque ripple in an interior permanent magnet (IPM) motor.

Brushless DC (BLDC) motors, such as permanent magnet (PMBLDC or PMSM) motors, provide a number of advantages over brushed motors, including increased torque density, increased reliability and durability, and reduction of electromagnetic interference (EMI). Therefore, BLDC motors are commonly used for high performance industrial applications such as in electrically assisted power steering systems in vehicles. Electrically assisted power steering systems are quickly becoming a desirable alternative to the hydraulically assisted power steering systems. In such systems, an electric motor is connected to the steering rack via a gear mechanism. Sensors may be used to measure various parameters such as hand wheel torque and position, and a control system may use signals from the sensors, along with other vehicle operating parameters to facilitate control over the electric motor drive and to thereby lend desirable steering characteristics to the vehicle.

While use of electrical motors in systems such as electrical power steering assist systems offers many advantages, configuring a BLDC motor to produce an acceptable set of output characteristics is not without challenges. A BLDC motor includes a plurality of permanent magnets fixed to a moving assembly (i.e., a rotor assembly), which rotates within, and relatively to, a fixed armature (i.e., a stator assembly). Outboard of the rotor assembly, the stator assembly hosts the motor windings such that they may be cooled by conduction rather than convection, facilitating the complete enclosure of the motor assembly for improved protection from infiltration of water, dirt, and/or other foreign matter. An Interior Permanent Magnet (IPM) motor comprises a plurality of magnet blocks that are embedded internally within the rotor core to provide for improved magnet retention relative to motors wherein magnets are mounted to the external surfaces of the rotor core.

Unfortunately, as the permanent magnets mounted in or on the rotor interact with the static structure (e.g., the slots) of the stator, various periodically varying phenomena, such as torque ripple, vibrations and speed pulsations, may be experienced. These unfavorable characteristics are generally related to the magnitude, and variations in magnitude, of cogging torque, which is also known as detent or ‘no-current’ torque. Because cogging torque is caused by interaction between the magnets of the rotor and the static structure, cogging torque varies with changes in rotor position. Cogging torque may be very noticeable at low rotor speeds, causing jerkiness in motor output. Accordingly, it is desirable to reduce cogging torque and increase motor output torque in a BLDC motor.

Various techniques have been used in attempts to reduce torque ripple and increase motor output torque. These include magnet pole shaping, linear skewing of rotor magnets or stator, step-skewing of the magnets, slot/pole combination, magnet shaping, and incorporation of dummy notches in stator teeth. Unfortunately, though, efforts to reduce torque ripple and increase motor output torque in IPM motors have achieved only limited success because IPM motors typically include relatively small air gaps and relatively simple rectangular magnet shapes. As a result, the potential for reducing torque ripple in IPM motors may be limited.

Accordingly, it is desirable to have an improved system and method for reducing torque ripple in IPM motors.

### SUMMARY OF THE INVENTION

In one exemplary embodiment of the invention, an interior permanent magnet motor comprises a rotor assembly disposed within a stator assembly. The rotor assembly is configured for rotating about a central axis relatively to the stator assembly. The rotor assembly defines a plurality of magnet pockets within the rotor assembly along a radially outboard surface of the rotor assembly. Each magnet pocket is substantially rectangular in cross-sectional shape, and each magnet pocket is configured to facilitate insertion of a plurality of permanent magnets into and retention of the plurality of permanent magnets within, the magnet pocket. The rotor assembly further comprises a plurality of permanent magnet segments disposed in each magnet pocket.

The above features and advantages and other features and advantages of the invention are readily apparent from the following detailed description of the invention when taken in connection with the accompanying drawings.

### BRIEF DESCRIPTION OF THE DRAWINGS

The subject matter which is regarded as the invention is particularly pointed out and distinctly claimed in the claims at the conclusion of the specification. The foregoing and advantages and details appear, by way of example only, in the following detailed description of embodiments taken in conjunction with the accompanying drawings in which:

FIG. 1 is a drawing showing a cross section of an exemplary embodiment of an IPM motor;

FIG. 2 is a drawing showing a cross section of a portion of an exemplary embodiment of an IPM motor;

FIG. 3 is a drawing showing a cross section of a portion of an exemplary embodiment of an IPM motor; and

FIG. 4 illustrates an exemplary method for reducing torque ripple in an interior permanent magnet motor.

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

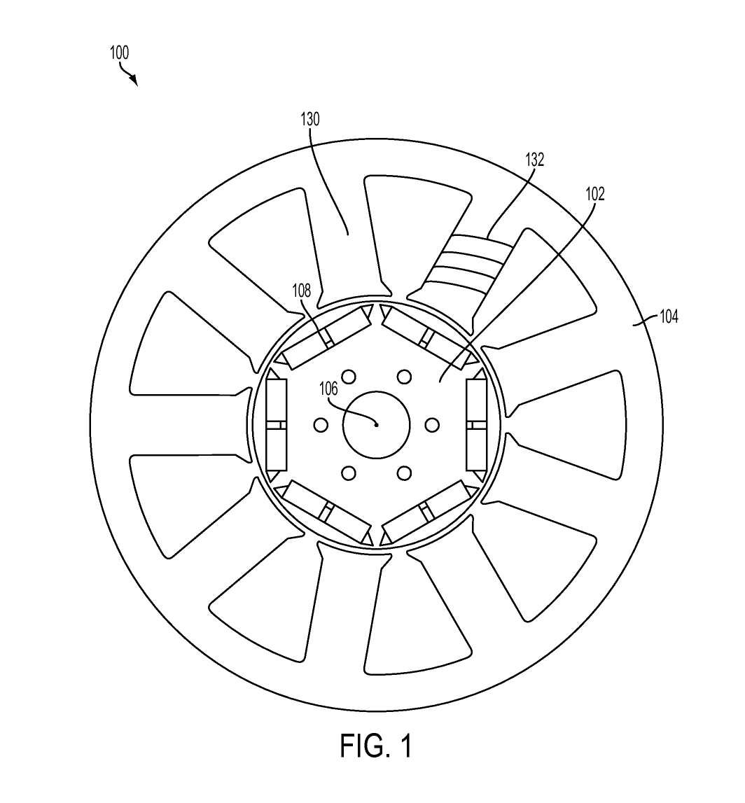

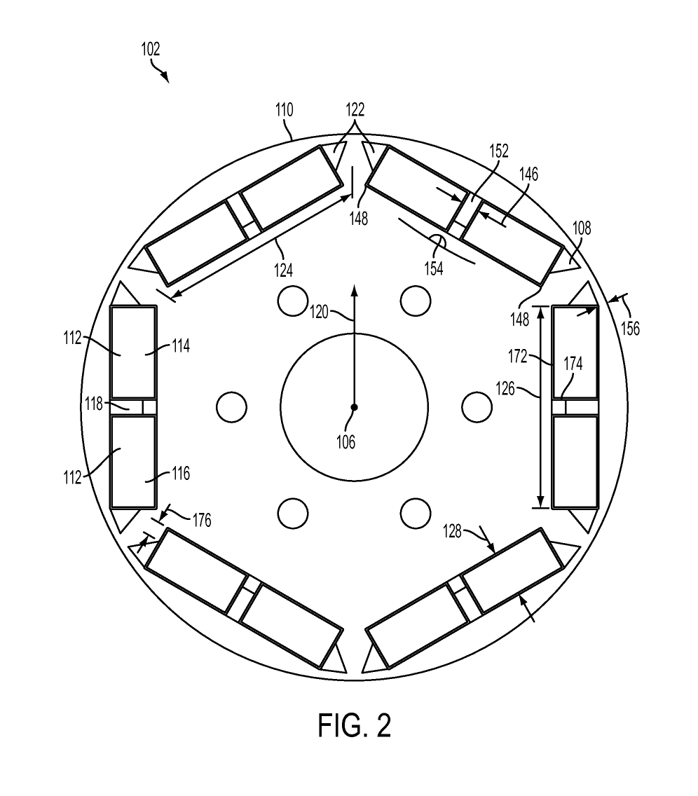

Referring now to the Figures, in which the invention will be described with reference to specific embodiments, without limiting same, FIG. 1 shows a cross section of an exemplary embodiment of an IPM motor 100 comprising a rotor assembly 102 that is disposed for rotation within, and relatively to, a stator assembly 104. FIG. 2 shows a cross section of an exemplary rotor assembly 102. As shown in FIG. 1 and FIG. 2, the rotor assembly 102 is configured to rotate about a central axis 106 and defines a plurality of magnet pockets 108 distributed within the rotor assembly 102 along a radially outboard surface 110 of the rotor assembly 102. Disposed in each of the magnet pockets 108 is a group of permanent magnet segments 112. Each group of permanent magnet segments 112 comprises a first magnet segment 114 and a second magnet segment 116, with each group of permanent magnet segments 112 representing a single magnet pole within the rotor assembly 102.

As shown in FIG. 1 and FIG. 2, in an exemplary embodiment, a plurality (e.g., six) of magnet pockets 108 are distributed along the radially outboard surface 110 of the rotor assembly 102. Each of the magnet pockets 108 is substantially rectangular in cross-sectional shape having a magnet pocket length 126 along a chord 124 of the rotor assembly 102. Each of the magnet pockets 108 is configured to facilitate insertion of a group of permanent magnet segments 112 into each of the magnet pockets 108 while also providing acceptable retention and reliable positioning of the group of permanent magnet segments 112 within each of the magnet pockets 108. An angular deviation 154 is defined by the relative orientations of adjacent permanent magnet segments 112 within each magnet pocket. In an exemplary embodiment, as shown in FIG. 2, an angular deviation 154 between adjacent magnet segments is approximately 180 degrees. Put another way, in accordance with this embodiment, first magnet segment 114 and second magnet segment 116 within each magnet pocket are arranged in parallel to one another.

Each of the magnet pockets 108 has a magnet pocket length 126 along a chord 124 of the rotor assembly 102 that is sized so that each of the magnet pockets 108 occupies approximately 90 percent of the available chord length along the edge of the rotor assembly 102. The remaining ten percent of the chord length provides room for a spacing to be defined between adjacent radially outward magnet pocket corners 122. A magnet width 128 of each of the magnet pockets 108 along the radial direction 120 is approximately half as great as the magnet pocket length 126 of each of the magnet pockets 108.

Radially outward magnet pocket corners 122 of the magnet pockets 108 may be shaped (e.g., creating a triangular air gap in the rotor) such that spacing between adjacent radially outward magnet pocket corners 122 is approximately one eighth of the magnet pocket length 126 or one fourth of the magnet width 128. Additionally, each magnet pocket may be disposed at a pocket inset distance 156 from the radially outboard surface 110 of the rotor assembly 102 such that the pocket inset distance 156 is approximately equal to one sixth of the magnet width 128.

A group of permanent magnet segments 112 is positioned within each of the magnet pockets 108 so as to define an inter-segment air gap 152 having an air gap width 118 between the first magnet segment 114 and a second magnet segment 116. In an exemplary embodiment, the air gap width 118 is oriented substantially along a radial direction 120 of the rotor assembly 102. A magnet gap width 146 of the air gap width 118 is approximately equal to one sixth of the magnet pocket length 126 or one third of the magnet width 128.

The air gap may extend only partially across the radial width of the magnet pockets 108 such that the air gap extends only from a mid-pocket position 174 toward the radially outward edge of the magnet pocket. The mid-pocket position 174 may be positioned away from the radially inward edge 172 of the magnet pocket approximately the same distance as the magnet pocket corner width 176. Radially inward corners 148 of the magnet pockets 108 are imbedded in solid material for approximately a magnet pocket corner width 176 of approximately one third of the magnet segment width, a dimension that is approximately equal to the air gap width 118, or approximately one sixth of magnet pocket length 126. Magnet pocket corner width 176, air gap width 118 dimensions is to guide magnet into pockets.

The stator assembly 104 includes a plurality of winding posts 130, each supporting a wire coil 132. At the radially inward end 134 of each of the winding posts 130 is a stator tooth 138. Each pair of adjacent stator teeth 138 is separated by a slot opening 136. A slot opening width 140 is chosen to be quite small for segmented and chained cores to aid in reducing torque ripple. In combination, the stator teeth 138 define an inner surface 142 of the stator assembly 104 having an inner surface radius 144. In an exemplary embodiment, the inner surface 142 is generally substantially cylindrical in shape (i.e., its inner surface radius 144 is substantially constant) and is oriented substantially symmetrically about the central axis 106. In an exemplary embodiment, the inner surface 142 of the stator assembly 104 is circular in cross-section.

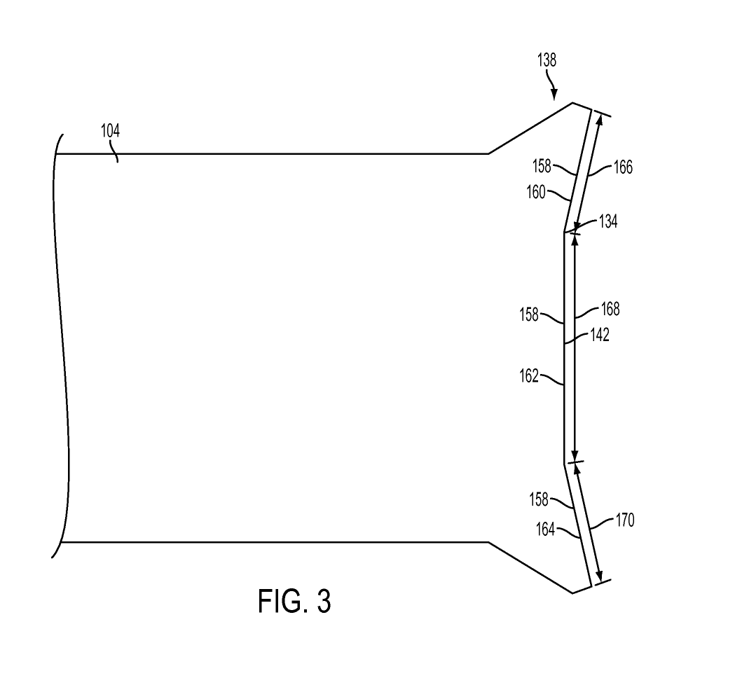

In another exemplary embodiment, the inner surface 142 of each of the stator teeth 138 defines a plurality of planar stator tooth surfaces 158. In one such embodiment, as shown in FIG. 3, the inner surface 142 of each of the stator teeth 138 defines a leading planar stator tooth surface 160, an intermediate planar stator tooth surface 162, and a trailing planar stator tooth surface 164. In an exemplary embodiment, a leading chord length 166 of the leading planar stator tooth surface 160 is substantially equal to a trailing chord length 170 of the trailing planar stator tooth surface 164, and an intermediate chord length 168 of the intermediate planar stator tooth surface 162 is approximately equal to a sum of the leading chord length 166 and the trailing chord length 170.

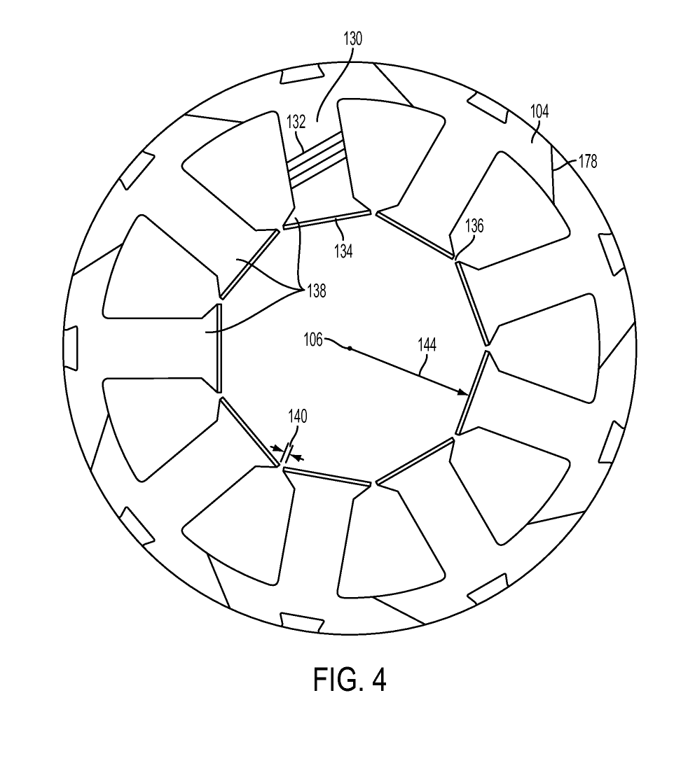

In an exemplary embodiment, as shown in FIG. 4, a stator assembly 104 is segmented such that a stator assembly 104 comprises a plurality (e.g., nine) of stator segments. In such a segmented stator assembly 104, adjacent stator segments meet at a segment interface line 178. It has been discovered that the orientation of the segment interface line 178 can have a substantial impact on both torque ripple and cogging torque. It has also been discovered that reductions in both torque ripple and cogging torque can be realized with a segmented stator assembly 104, particularly where the segment interface line 178 is arranged so as to be angled relatively to a radial direction 120 extending from the center of the stator assembly 104 (i.e., from the axis of rotation of the rotor assembly 102).

In an exemplary embodiment, the segment interface line 178 may be rotated relatively to the radial direction 120 to mitigate certain ripple components caused by interactions between the rotor assembly 102 and the stator assembly 104. For example, in a configuration wherein the rotor assembly 102 has six poles and the stator assembly 104 has nine slots, the ripple component will be of the 18^{th} order, which will repeat every 20 degrees of rotation (i.e., having a periodicity of approximately 20 degrees). To mitigate the ripple components in such a rotor/stator combination, it may be beneficial to rotate the segment interface line 178, relative to the radial direction 120, by an amount that is between approximately five degrees and 20 degrees, preferably closer to approximately 20 degrees. For other rotor/stator configurations, the amount of angular deviation (i.e., rotation of the segment interface line 178) relative to the radial direction 120 will depend upon the numbers of poles on the rotor assembly 102 and the number of slots on the stator assembly 104. For example, with a rotor assembly 102 having 12 poles, and a stator assembly 104 having 8 slots, the expected ripple component will be of the 24^{th} order, and the configuration would be expected to have a periodicity of approximately 15 degrees. Thus, in accordance with an exemplary embodiment, it may be beneficial, for the purpose of mitigating the ripple components, to rotate the segment interface line 178, relative to the radial direction 120, by an amount that is between approximately five degrees and 15 degrees, preferably closer to approximately 15 degrees.

In accordance with exemplary embodiments of the invention, adjustments to torque ripple and/or output torque may be achieved by adjusting the spacing between adjacent radially outward magnet pocket corners 122, magnet pocket corner width 176, magnet pocket length 126, magnet width 128, slot opening width 140, and shaping of the stator teeth 138. Each of these parameters may be configured so as to reduce torque ripple and increase motor output torque. The exemplary configuration depicted in the drawings provides good electromagnetic torque response with six rectangular bar magnet poles.

In the disclosed configuration, the spacing between adjacent radially outward magnet pocket corners 122, pocket inset distance 156, air gap width 118, magnet pocket corner width 176 have been optimally minimized to reduce the ripple torque and to maximize the motor average torque. The magnet pocket design, including the magnet pocket corner width 176 and the air gap width 118, considers the need to be able to guide magnets into pockets and thus improves the positioning and retention of the magnet in the magnet slot, helping to reduce the ripple associated with the magnet positioning into the pocket. A back-pocket profile may be configured so as to facilitate plastic injection and also has influence on the output torque. The magnet dimensions are chosen so that the combined rotor structures gives lower torque ripple but higher average torque.

The slot opening width 140 can be chosen to produce optimum ripple torque. For a motor comprising a stator with twenty-seven slots and a stator with six poles, the inner arc of the stator teeth 138 is concentric to the rotor outer arc. On the other hand, the inner arc of the stator may be configured as a combination of flat planes for a motor comprising a stator having nine slots and a rotor with six poles. However in both designs the radially inner surface 142 of the stator can be flat, concave or convex shape with respect to the center axis. Both configurations show better output torque response. In an exemplary embodiment, average torque output increases 4.5% increase at rated current while ripple torque decreases 50% at rated current, and magnet volume decreases 12%.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as being limited by the foregoing description.

Having thus described the invention, it is claimed:

1. An interior permanent magnet motor comprising:
a rotor assembly disposed within a stator assembly;
the rotor assembly being configured for rotating about a central axis relatively to the stator assembly;
the rotor assembly defining a plurality of magnet pockets within the rotor assembly along a radially outboard surface of the rotor assembly,
each magnet pocket being substantially rectangular in cross-sectional shape, and
each magnet pocket being configured to facilitate insertion of a plurality of permanent magnets into and retention of the plurality of permanent magnets within, the magnet pocket;
the rotor assembly further comprising a plurality of permanent magnet segments disposed in each magnet pocket.

2. The interior permanent magnet motor of claim 1, wherein the plurality of permanent magnet segments disposed in each magnet pocket are arranged so as to define an air gap between adjacent magnet segments.

3. The interior permanent magnet motor of claim 2, wherein the plurality of permanent magnets disposed in each magnet pocket comprises a first magnet segment and a second magnet segment.

4. The interior permanent magnet motor of claim 2,
wherein the plurality of permanent magnet segments disposed in each magnet pocket forms a single magnet pole.

5. The interior permanent magnet motor of claim 2,
wherein each magnet of the plurality of permanent magnet segments disposed in each magnet pocket is arranged substantially in parallel with each of the other magnets disposed in the magnet pocket.

6. The interior permanent magnet motor of claim 4, wherein a magnet width of each magnet pocket along a radial direction is approximately half as great as a magnet pocket length of each magnet pocket.

7. The interior permanent magnet motor of claim 6:
wherein each magnet has two radially outward magnet pocket corners; and
wherein each radially outward magnet pocket corner is shaped such that spacing between adjacent radially outward magnet pocket corners is approximately one eighth of the magnet pocket length.

8. The interior permanent magnet motor of claim 6:
wherein each magnet pocket is disposed at a pocket inset distance from the radially outboard surface of the rotor assembly; and
wherein the pocket inset distance is approximately equal to one sixth of the magnet width.

9. The interior permanent magnet motor of claim 3, wherein, within each magnet pocket, the first magnet segment and the second magnet segment are positioned so as to define an inter-segment air gap defining an air gap width between the first magnet segment and the second magnet segment.

10. The interior permanent magnet motor of claim 9, wherein the air gap is oriented substantially along a radial direction of the rotor assembly.

11. The interior permanent magnet motor of claim 9, wherein an air gap width is approximately equal to one sixth of a magnet pocket length of each magnet pocket.

12. The interior permanent magnet motor of claim 9, wherein the air gap extends only partially across a radial width of the magnet pocket such that the air gap extends only from a mid-pocket position toward a radially outward edge of the magnet pocket.

13. The interior permanent magnet motor of claim 1, wherein the stator assembly comprises a plurality of winding posts, each having a stator tooth at a radially inward end of each of the plurality of winding posts, each stator tooth being separated from an adjacent stator tooth by a slot opening.

14. The interior permanent magnet motor of claim 13, wherein an inner surface of the stator tooth defines a plurality of planar stator tooth surfaces.

15. The interior permanent magnet motor of claim 14, wherein the plurality of planar stator tooth surfaces comprises a leading planar stator tooth surface, an intermediate planar stator tooth surface, and a trailing planar stator tooth surface.

16. The interior permanent magnet motor of claim 15, wherein a leading chord length of the leading planar stator tooth surface is substantially equal to a trailing chord length of the trailing planar stator tooth surface.

17. The interior permanent magnet motor of claim 16, wherein an intermediate chord length of the intermediate planar stator tooth surface is approximately equal to a sum of the leading chord length and the trailing chord length.

18. The interior permanent magnet motor of claim 1, wherein the stator assembly comprises a plurality of stator segments such that adjacent stator segments meet at a segment interface line.

19. The interior permanent magnet motor of claim 18, wherein the segment interface line is arranged so as to be angled relatively to a radial line extending from a center of the stator assembly.

20. The interior permanent magnet motor of claim 19, wherein the segment interface line is arranged so as to define an angle of approximately 45 degrees relative to a radial direction.
